(19) United States
(12) Patent Application Publication
(10) Pub. No.: US 2024/0419560 A1
(43) Pub. Date: Dec. 19, 2024

(54) LEARNING APPARATUS, ANOMALY DETECTION APPARATUS, LEARNING METHOD, ANOMALY DETECTION METHOD, AND PROGRAM

(71) Applicant: NIPPON TELEGRAPH AND TELEPHONE CORPORATION, Tokyo (JP)

(72) Inventors: Yoichi MATSUO, Tokyo (JP); Kengo TAJIRI, Tokyo (JP)

(21) Appl. No.: 18/698,160

(22) PCT Filed: Oct. 28, 2021
(86) PCT No.: PCT/JP2021/039838

§ 371 Date: Apr. 3, 2024

(51) Int. Cl. G06F 11/14

(52) U.S. Cl. CPC G06F 11/1476

(57) ABSTRACT

A learning apparatus according to an embodiment includes: an input unit that inputs a set of normal data of a first system serving as a target domain and a set of normal data of a second system serving as a source domain; and a learning unit that learns a model including a first encoder having data of the target domain as an input, a second encoder having data of the source domain as an input, a discriminator having output data of either the first encoder or the second encoder as an input to discriminate whether the output data is data indicating a feature of either the target domain or the source domain, and a DeepSVDD having the output data as an input, by using the set of normal data of the first system and the set of normal data of the second system.

### TECHNICAL FIELD

The present invention relates to a learning apparatus, an anomaly detecting apparatus, a learning method, a method for detecting an anomaly, and a program.

### BACKGROUND ART

For a business operator who operates an information and communication technology (ICT) system, it is one of important tasks to grasp a state of an anomaly occurring in the ICT system and quickly respond to the anomaly. Hence, research on a method for detecting an anomaly occurring in an ICT system at an early stage has been conducted in the related art. In particular, there has been proposed an unsupervised anomaly detecting technique using deep learning (DL) in which an anomaly is detected by learning a normal state using normal data of an ICT system and calculating a degree of deviation from the normal state at the time of a test (for example, Non Patent Literatures 1 and 2).

The ICT system provides various services, and users who use these services also have various tendencies. Hence, in order to learn a normal state of the ICT system by the unsupervised anomaly detecting technique using the DL, a large amount of normal data is required. In general, since the normal time of the ICT system is often longer than the abnormal time, in the ICT system that is operated for a long period of time, it is possible to collect a large amount of normal data.

### CITATION LIST

### Non Patent Literature

Non Patent Literature 1: Y. Ikeda, K. Ishibashi, Y. Nakano, K. Watanabe, K. Tajiri, and R. Kawahara, “Human-Assisted Online Anomaly Detection with Normal Outlier Retraining,” ACM SIGKDD 2018 Workshop ODD v5.0, August 2018.
Non Patent Literature 2: Y. Ikeda, K. Tajiri, Y. Nakano, K. Watanabe, K. Ishibashi, “Unsupervised Estimation of Dimensions Contributing to Detected Anomalies with Variational Autoencoders, “AAAI-19 Workshop on Network Interpretability for Deep Learning, 2019.

### SUMMARY OF INVENTION

### Technical Problem

However, there is a case where only a small amount of normal data can be collected. For example, immediately after a new ICT system is constructed, a sufficient amount of normal data cannot be collected. Hence, an anomaly cannot be detected by an unsupervised anomaly detecting technique until a sufficient amount of normal data is collected.

In addition, for example, in a case where a normal state of an ICT system has changed by providing a new service, a conventional unsupervised anomaly detecting technique cannot be used, and thus, similarly, anomaly cannot be detected until a sufficient amount of normal data is collected.

An embodiment of the present invention has been made in view of such points described above, and an object thereof is to realize unsupervised anomaly detection in a target system with a small amount of normal data.

### Solution to Problem

In order to achieve the above-described object, a learning apparatus according to an embodiment includes: an input unit that inputs a set of normal data of a first system serving as a target domain and a set of normal data of a second system serving as a source domain; and a learning unit that learns a model including a first encoder having data of the target domain as an input, a second encoder having data of the source domain as an input, a discriminator having output data of either the first encoder or the second encoder as an input to discriminate whether the output data is data indicating a feature of either the target domain or the source domain, and a DeepSVDD having the output data as an input, by using the set of normal data of the first system and the set of normal data of the second system.

### Advantageous Effects of Invention

It is possible to realize unsupervised anomaly detection in a target system with a small amount of normal data.

### BRIEF DESCRIPTION OF DRAWINGS

FIG. 1 is a diagram schematically illustrating an example of a model.

FIG. 2 is a diagram illustrating an example of a hardware configuration of an anomaly detecting apparatus according to this embodiment.

FIG. 3 is a diagram illustrating an example of a functional configuration of the anomaly detecting apparatus according to the embodiment.

FIG. 4 is a flowchart illustrating an example of a flow of overall processes executed by the anomaly detecting apparatus according to the embodiment.

### DESCRIPTION OF EMBODIMENTS

Hereinafter, an embodiment of the present invention will be described. In the embodiment, an unsupervised anomaly detecting technique of transferring information obtained at the time of learning a normal state of an ICT system having a large amount of normal data to an ICT system having a small amount of normal data will be described focusing on a point that a configuration and a function are different for each ICT system, but in a case where the ICT system has a similar configuration and a similar function, ICT systems have similar normal states. This unsupervised anomaly detecting technique enables to obtain an anomaly detector capable of detecting an anomaly in an ICT system (hereinafter, also referred to as a target system) having only a small amount of normal data.

In addition, an anomaly detecting apparatus 10 that creates an anomaly detector and detects an anomaly of the target system by the anomaly detector by the unsupervised anomaly detecting technique will be described.

### <Unsupervised Anomaly Detecting Technique>

Hereinafter, a theoretical configuration of the unsupervised anomaly detecting technique according to the embodiment will be described.

First, an ICT system having a large amount of normal data is set as a source domain S, and an ICT system (target system) having a small amount of normal data is set as a target domain T.

In addition, assuming that one item of normal data obtained from the source domain S is n-dimensional vector data xₛ=[xₗ^{(s)}, . . . , xₙ^{(s)}], a data set including the n-dimensional vector data xₛ is set as follows.

$${D}_{S} = \{ {x}_{1} , … {x}_{\vert {D}_{S} \vert} \} \qquad [ Math . 1 ]$$

Here, n represents the number of types of data obtained in the source domain S, and |D₃| represents the number of n-dimensional vector data.

Similarly, assuming that one item of normal data obtained from the target domain T is m-dimensional vector data xₜ=[x₁^{(t)}, . . . , xₘ^{(t)}], a data set including the m-dimensional vector data xₜ is set as follows.

$${D}_{T} = \{ {x}_{1} , … {x}_{\vert {D}_{T} \vert} \} \qquad [ Math . 2 ]$$

Here, m represents the number of types of data obtained in the target domain T, and |D_{T}| represents the number of m-dimensional vector data.

Next, a model used in the unsupervised anomaly detecting technique according to the embodiment will be described. As a technique for detecting an anomaly in each of the source domain S and the target domain T, an encoder which is a type of DL and a deep support vector data description (DeepSVDD: Support vector data description method using deep learning) (Reference Literature 1) are used. More specifically, after input data (normal data) is compressed by an encoder E, learning is performed so that a hypersphere (a volume thereof or an area of hyperspherical plane) is minimized when the compressed data (feature value) is mapped onto the hyperspherical plane by DeepSVDD. Accordingly, after the learning, anomaly detection is performed by the SVDD and an encoder having data of the target domain as an input. Hereinafter, the encoder of the source domain S is denoted by E_{S}, a parameter thereof is denoted by θ_{S}, the encoder of the target domain is denoted by E_{T}, and a parameter thereof is denoted by θ_{E}.

In addition, as a technique for transferring knowledge in a certain domain to another domain, a technique of using a generative adversarial network (GAN) is known (Reference Literature 2). In this respect, in the unsupervised anomaly detecting technique according to the embodiment, a model obtained by combining the encoders E_{S} and E_{T} and the DeepSVDD is used in the GAN-based transfer learning technique.

Specifically, by extracting feature values from the source domain S and the target domain T by the encoders E_{S} and E_{T}, respectively, an expression (feature) that can be transferred from the source domain S is acquired and applied to the target domain T. In addition, a discriminator D(⋅; θ_{D}) that discriminates which domain causes output E_{S}(xₛ; θ_{S}) or E_{T}(xₜ; θ_{T}) of the encoder E_{S}(⋅; θ_{S}) or E_{T}(⋅; θ_{T}) to be made (that is, discriminates which domain causes input data of the encoders to be extracted, from the outputs of the encoders) is prepared. Here, the discriminator D(⋅; θ_{D}) is expressed by a neural network, and θ_{D} represents a parameter thereof. That is, the discriminator D is a neural network that discriminates whether the input data is data from the source domain or data from the target domain. Further, a dimension of an input layer of the discriminator D(⋅; θ_{D}) and a dimension of an input layer of the encoders E_{S}(⋅; θ_{S}) and E_{T}(⋅; θ_{T}) are the same (for example, both dimensions are a dimension number k).

The above-described model is a learning target. Hereinafter, i is an index of data input to the model which is the learning target, and i=1, . . . , |D_{S}|+|D_{T}|. In addition, it is assumed that only either sᵢ∈{1, . . . , |D_{S}|} or tᵢ∈{1, . . . , |D_{T}|} is satisfied for each i. Further, regarding i with which sᵢ∈{1, . . . , |D_{S}|} is not satisfied, for example, sᵢ=|D_{S}|+1 or the like may be satisfied. Similarly, regarding i with which tᵢ∈{1, . . . , |D_{T}|} is not satisfied, for example, tᵢ=|D_{T}|+1 or the like may be satisfied. Hereinafter, symbols (subscripts) of “sᵢ” and “tᵢ” assigned at a lower right position of “x” are expressed as “x_{s_i}” and “x_{s_i}” in the text of the specification.

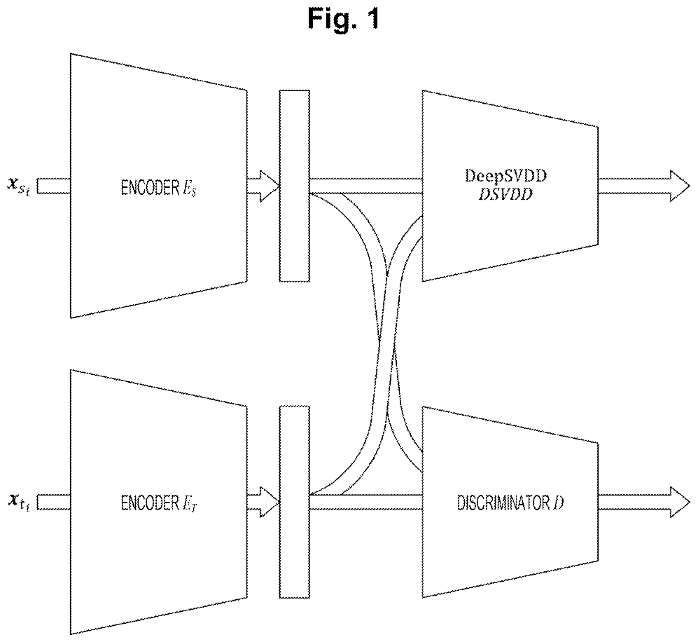

In this case, a schematic diagram of the model which is the learning target is illustrated in FIG. 1. In a case where either x_{s_i} or x_{t_i} is input to the model for each i, and x_{s_i} is input to the model as illustrated in FIG. 1, an output E_{S}(x_{s_i}; θ_{S}) of an encoder of the source domain is input to both the DeepSVDD DSVDD and the discriminator D. On the other hand, in a case where x_{t_i} is input to the model, an output E_{T} (x_{t_i}; θ_{T}) of an encoder of the target domain is input to both the DeepSVDD DSVDD and the discriminator D.

Next, a loss function of the model which is the learning target is defined.

First, a loss function of the discriminator D(⋅; θ_{D}) is defined below.

$${L}_{D} ( {θ}_{S} , {θ}_{T} , {θ}_{D} ) = \{ \begin{matrix}{L}_{B} ( D ( {E}_{S} ( {x}_{{s}_{i}} ; {θ}_{S} ) ; {θ}_{D} , {d}_{i} ) , & for i ∈ {N}_{S} \\ {L}_{B} ( D ( {E}_{T} ( {x}_{{t}_{i}} ; {θ}_{T} ) ; {θ}_{D} , {d}_{i} ) , & for i ∈ {N}_{T}\end{matrix} \qquad [ Math . 3 ]$$

Here, L_{S} represents binary cross entropy. In addition, dᵢ represents whether an i-th item of data is in the source domain or the target domain. For example, when the i-th item of data input to the model is in the source domain, dᵢ=0 is set, and when the i-th item of data is in the target domain, dᵢ=1 is set. Further, N_{S} is a set of i satisfying sᵢ∈{1, . . . , |D_{S}|}, and N_{T} is a set of i satisfying tᵢ∈{1, . . . , |D_{T}|}. Further, note that input data to the model is x_{s_i}∈D_{S} when i∈N_{S}, and input data to the model is x_{t_i}∈D_{T} when i∈N_{T}.

Next, a loss function of the DeepSVDD DSVDD (⋅; θ_{DSVDD}) is defined below.

$${L}_{DSVDD} ( {θ}_{S} , {θ}_{T} , {θ}_{DSVDD} ) = \qquad [ Math . 4 ]$$

$$\{ \begin{matrix}{‖ DSVDD ( {E}_{S} ( {x}_{{s}_{i}} ; {θ}_{S} ) ; {θ}_{DSVDD} ) - c ‖}^{2} , & for i ∈ {N}_{S} \\ {‖ DSVDD ( {E}_{T} ( {x}_{{T}_{i}} ; {θ}_{T} ) ; {θ}_{DSVDD} ) - c ‖}^{2} , & for i ∈ {N}_{T}\end{matrix}$$

Here, θ_{DSVDD} represents a parameter of DSVDD. In addition, c is a constant given in advance before the learning of the model but is calculated from a data set for learning (that is, D_{S} and D_{T}). Specifically, after parameters θ_{S} and θ_{T} of the encoders E_{S}(⋅; θ_{S}) and E_{T}(⋅; θ_{T}) and the parameter θ_{DSVDD} of the DeepSVDD DSVDD (⋅; θ_{DSVDD}) are initialized, DSVDD (E_{S} (xₛ; θ_{S}); θ_{DSVDD}) and DSVDD(E_{S}(xₜ; θ_{T}); θ_{DSVDD}) are calculated for each xₛ∈D_{S} and each xₜ∈D_{T}, and an average thereof is defined as c.

Collectively, the loss function of the model which is the learning target is defined below.

$$L ( {θ}_{S} , {θ}_{T} , {θ}_{DSVDD} , {θ}_{D} ) = \qquad [ Math . 5 ]$$

$$\frac{1}{\vert {N}_{S} \vert} {\sum }_{i ∈ {N}_{S}} ( {L}_{D} + {L}_{DSVDD} ) + \frac{1}{\vert {N}_{T} \vert} {\sum }_{i ∈ {N}_{T}} ( {L}_{D} + {L}_{DSVDD} ) + \frac{λ}{2} {\sum }_{l = 1}^{L} {‖ {W}^{l} ‖}_{F}^{2}$$

Here, W¹ represents a weight of an 1-th layer of a neural network representing DeepSVDD DSVDD, L represents the number of layers, and λ represents a hyperparameter. In addition, ∥⋅∥_{F} represents the Frobenius norm. Further, note that W¹ is included in the parameter θ_{DSVDD}. In addition, note that |N_{S}|=|D_{S}| and |N_{T}|=|D_{T}|.

Accordingly, parameter learning is performed to minimize a loss function expressed in Expression 5 above. That is, each parameter learning is performed to minimize a hypersphere around c with respect to the encoders E_{S} and E_{T} and the DeepSVDD DSVDD and maximize discrimination performance of the discriminator D with respect to the encoders E_{S} and E_{T} and the discriminator D. Specifically, the parameters learning is performed as follows.

$${min}_{{θ}_{S} , {θ}_{T} , {θ}_{DSVDD}} {max}_{{θ}_{D}} L ( {θ}_{S} , {θ}_{T} , {θ}_{DSVDD} , {θ}_{D} ) \qquad [ Math . 6 ]$$

Further, various parameter learning techniques can be considered, and appropriate techniques may be used. For example, optimization using Adam (Reference Literature 3) can be used.

After learning is performed by Expression 6 above, anomaly detection is performed by DSVDD(E_{T}(⋅; θ_{T}); θ_{DSVDD}) which completes the learning. Specifically, data which is an anomaly detection target in the target domain is set as x, and DSVDD (E_{T} (x; θ_{T}); θ_{DSVDD}) is calculated. In a case where a difference between DSVDD(E_{T}(x; θ_{T}); θ_{DSVDD}) and c exceeds a predetermined threshold, this case is determined as abnormal, otherwise a case is determined as normal. Further, the threshold can be optionally set, and for example, it is conceivable to use μ+σ², μ−σ², or the like as a threshold when a difference between DSVDD(E_{T}(xₜ; θ_{T}); θ_{DSVDD}) and c for each xₜ∈D_{T} is calculated using DSVDD(E_{T}(⋅; θ_{T}); θ_{DSVDD}) obtained after the learning, an average thereof is represented by μ, and a variance thereof is represented by σ².

### <Hardware Configuration of Anomaly Detecting Apparatus 10>

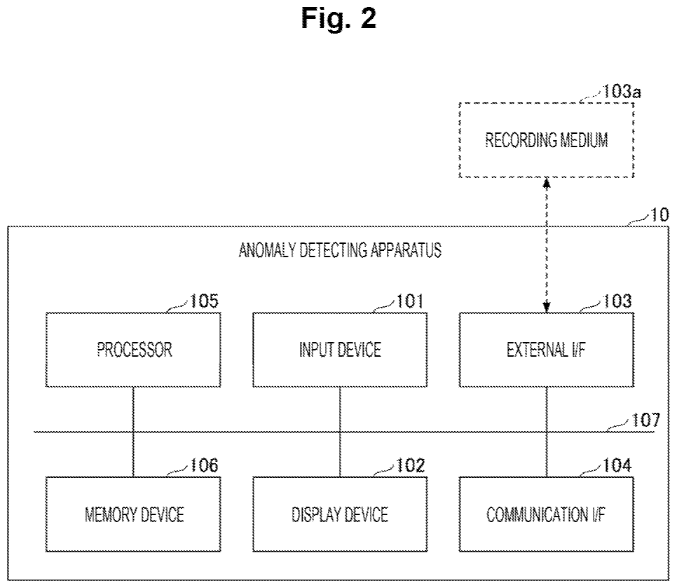

Next, a hardware configuration of an anomaly detecting apparatus 10 according to the embodiment will be described with reference to FIG. 2. FIG. 2 is a diagram illustrating an example of the hardware configuration of the anomaly detecting apparatus 10 according to this embodiment.

As illustrated in FIG. 2, the anomaly detecting apparatus 10 according to the embodiment is realized by a hardware configuration of a general computer or computer system and includes an input device 101, a display device 102, an external I/F 103, a communication I/F 104, a processor 105, and a memory device 106. These devices of hardware are communicatively connected to each other via a bus 107.

The input device 101 is, for example, a keyboard, a mouse, a touch panel, or the like. The display device 102 is, for example, a display or the like.

The external I/F 103 is an interface with an external device such as a recording medium 103a. The anomaly detecting apparatus 10 can read and write in the recording medium 103a via the external I/F 103. Further, examples of the recording medium 103a include a compact disc (CD), a digital versatile disk (DVD), a secure digital memory card (SD memory card), and a universal serial bus (USB) memory card.

The communication I/F 104 is an interface for connecting the anomaly detecting apparatus 10 to a communication network. The processor 105 is, for example, any of various arithmetic devices such as a central processing unit (CPU) and a graphics processing unit (GPU). The memory device 106 is any of various storage devices such as a hard disk drive (HDD), a solid state drive (SSD), a random access memory (RAM), a read only memory (ROM), and a flash memory.

The anomaly detecting apparatus 10 according to the embodiment has the hardware configuration illustrated in FIG. 2, thereby being able to realize various types of processes to be described below. Further, the hardware configuration illustrated in FIG. 2 is an example, and the anomaly detecting apparatus 10 may have another hardware configuration. For example, the anomaly detecting apparatus 10 may include a plurality of the processors 105 or may include a plurality of the memory devices 106.

### <Functional Configuration of Anomaly Detecting Apparatus 10>

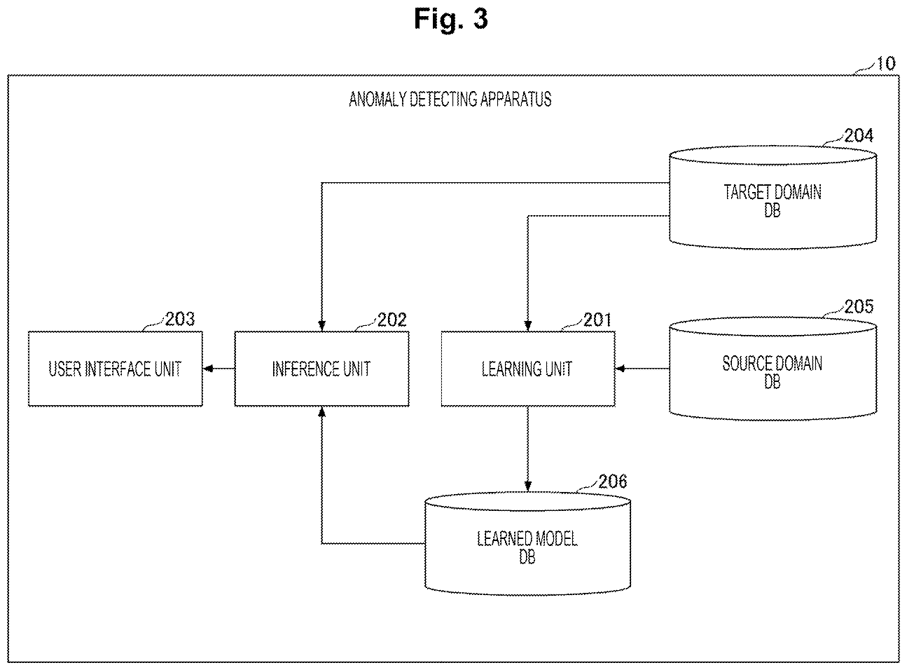

Next, another hardware configuration of the anomaly detecting apparatus 10 according to the embodiment will be described with reference to FIG. 3. FIG. 3 is a diagram illustrating an example of the functional configuration of the anomaly detecting apparatus 10 according to the embodiment.

As illustrated in FIG. 3, the anomaly detecting apparatus 10 according to the embodiment includes a learning unit 201, an inference unit 202, and a user interface unit 203. Each of these units is realized, for example, by processes executed by the processor 105 according to one or more programs installed in the anomaly detecting apparatus 10.

In addition, the anomaly detecting apparatus 10 according to the embodiment includes a target domain DB 204, a source domain DB 205, and a learned model DB 206. Each of these DBs (databases) is realized by, for example, the memory device 106.

The learning unit 201 learns the model (that is, model including the encoders E_{S} and E_{T}, the DeepSVDD DSVDD, and the discriminator D) illustrated in FIG. 1, using the m-dimensional vector data xₜ stored in the target domain DB 204 and the n-dimensional vector data xₛ stored in the source domain DB 205. The model (hereinafter, also referred to as learned model) learned by the learning unit 201 is stored in the learned model DB 206.

When DSVDD(E_{T}(⋅; θ_{T}); θ_{DSVDD}) included in the learned model stored in the learned model DB 206 is used as an anomaly detector, the inference unit 202 determines whether or not an anomaly has occurred in a target system, using the anomaly detector and the m-dimensional vector data x as the anomaly detection target.

The user interface unit 203 outputs the determination result by the inference unit 202 to the user. For example, the user interface unit 203 outputs the determination result to a terminal or the like used by an operator or the like of the target system.

The target domain DB 204 stores a data set D_{T} of the target domain T. The source domain DB 205 stores a data set D_{S} of the source domain S. The learned model DB 206 stores a learned model.

Further, the functional configuration of the anomaly detecting apparatus 10 illustrated in FIG. 3 is an example, and other functional configurations may be used. For example, each functional unit and each DB may be arranged in a plurality of devices.

### <Flow of Overall Processes Executed by Anomaly Detecting Apparatus 10>

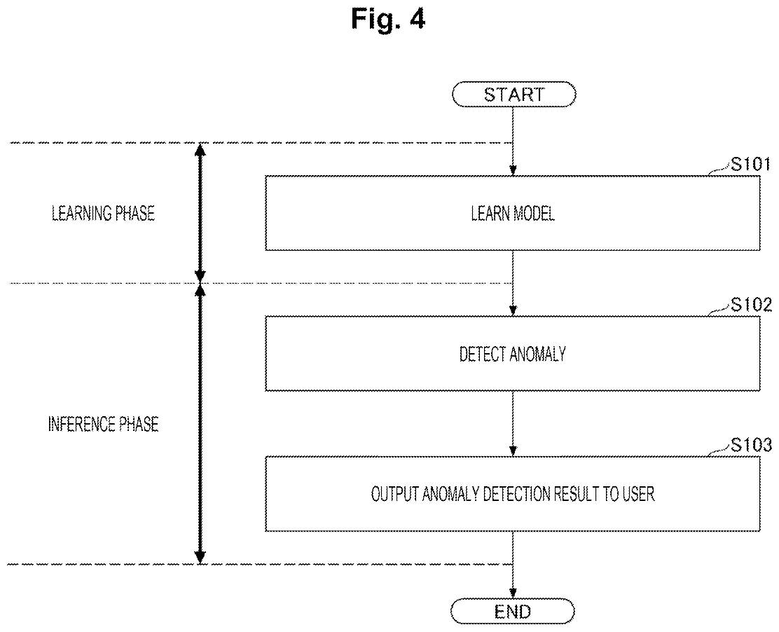

Next, a flow of overall processes executed by the anomaly detecting apparatus 10 according to the embodiment will be described with reference to FIG. 4. FIG. 4 is a flowchart illustrating an example of a flow of the overall processes executed by the anomaly detecting apparatus 10 according to the embodiment. Here, Step S101 in FIG. 4 is a process in a learning phase, and Steps S102 and S103 are processes in an inference phase. Further, the learning phase is a phase in which a model is learned, and the inference phase is a phase in which inference (that is, anomaly detection) is performed using a learned model. The learning phase is performed in advance before the inference phase.

Step S101: The learning unit 201 learns the model illustrated in FIG. 1 using the m-dimensional vector data xₜ stored in the target domain DB 204 and the n-dimensional vector data xₛ stored in the source domain DB 205. That is, the learning unit 201 learns the parameters of the model by Expression 6, by using an optimization technique such as Adam.

Step S102: The inference unit 202 determines whether or not an anomaly has occurred in a target system, using the anomaly detector and the m-dimensional vector data xₜ of the anomaly detection target, when DSVDD (ET(⋅; θT); θ_{DSVDD}) included in the learned model stored in the learned model DB 206 is used as an anomaly detector. That is, the inference unit 202 determines that, when a difference between DSVDD(E_{T}(x; θ_{T}); θ_{DSVDD}) and c exceeds a predetermined threshold, an anomaly has occurred and otherwise the target system is normal.

Step S103: The user interface unit 203 outputs the determination result (normal or abnormal) of Step S102 to the user. Further, the user interface unit 203 may output the result to the user only when the determination result of Step S102 is abnormal.

As described above, the anomaly detecting apparatus 10 according to the embodiment can detect the anomaly of the target system by the unsupervised anomaly detecting technique using the DL by transferring the information on the normal state of the ICT system having a large amount of normal data even when there is only a small amount of normal data of the target system.

Further, as described above, the anomaly detecting apparatus 10 has the learning phase and the inference phase, and in the embodiment, the same anomaly detecting apparatus 10 executes the learning phase and the inference phase, but these phases may be executed by different respective apparatuses. In addition, the anomaly detecting apparatus 10 in the learning phase may be referred to as a “learning apparatus” or the like.

The present invention is not limited to the above-mentioned specifically disclosed embodiments, and various modifications and changes, combinations with known technologies, and the like can be made without departing from the scope of the claims.

### REFERENCE LITERATURE

Reference Literature 1: Ruff, Lukas, et al. “Deep one-class classification.” International conference on machine learning. PMLR, 2018.
Reference Literature 2: Ajakan, H., Germain, P., Larochelle, H., Laviolette, F., Marchand, M.: Domain adversarial neural networks. arXiv preprint arXiv:1412.4446 (2014)
Reference Literature 3: Ruder, Sebastian. “An overview of gradient descent optimization algorithms.” arXiv preprint arXiv:1609.04747 (2016).

### REFERENCE SIGNS LIST

10 Anomaly detecting apparatus
101 Input device
102 Display device
103 External I/F
103a Recording medium
104 Communication I/F
105 Processor
106 Memory device
107 Bus
201 Learning unit
202 Inference unit
203 User interface unit
204 Target domain DB
205 Source domain DB
206 Learned model DB

1. A learning apparatus comprising:
a processor; and
a memory storing program instructions that cause the processor to:
input a set of normal data of a first system serving as a target domain and a set of normal data of a second system serving as a source domain; and
learn a model including a first encoder having data of the target domain as an input, a second encoder having data of the source domain as an input, a discriminator having output data of either the first encoder or the second encoder as an input to discriminate whether the output data is data indicating a feature of either the target domain or the source domain, and a deep support vector data description (DeepSVDD) having the output data as an input, by using the set of normal data of the first system and the set of normal data of the second system.

2. The learning apparatus according to claim 1,
wherein the program instructions cause the processor to learn a parameter of the first encoder, a parameter of the second encoder, and a parameter of the DeepSVDD to minimize a hypersphere when the output data is mapped on a hypersphere by the DeepSVDD and learns a parameter of the first encoder, a parameter of the second encoder, and a parameter of the discriminator to maximize determination performance of the discriminator.

3. The learning apparatus according to claim 1, wherein the number of data included in the set of normal data of the target domain is smaller than the number of data included in the set of normal data of the source domain.

4. An anomaly detecting apparatus comprising:
a processor; and
a memory storing program instructions that cause the processor to:
determine whether or not an anomaly has occurred in a system by using a first encoder and a DeepSVDD included in a model learned by the learning apparatus according to claim 1 and data of the system which is an anomaly detection target.

5. A learning method that is executed by a computer, the learning method comprising:
inputting a set of normal data of a first system serving as a target domain and a set of normal data of a second system serving as a source domain; and
learning a model including a first encoder having data of the target domain as an input, a second encoder having data of the source domain as an input, a discriminator having output data of either the first encoder or the second encoder as an input to discriminate whether the output data is data indicating a feature of either the target domain or the source domain, and a DeepSVDD having the output data as an input, by using the set of normal data of the first system and the set of normal data of the second system.

6. A method for detecting an anomaly, which is executed by a computer, the method comprising:
discriminating whether or not an anomaly has occurred in a system by using a first encoder and a DeepSVDD included in a model learned by the learning apparatus according to claim 1 and data of the system which is an anomaly detection target.

7. A non-transitory computer-readable recording medium having stored therein a program for causing a computer to execute the learning method according to claim 5.

8. The learning apparatus according to claim 1, wherein the program instructions cause the processor to determine whether or not an anomaly has occurred in a system by using a first encoder and a DeepSVDD included in the learned model and data of the system which is an anomaly detection target.
